(19) United States
(12) Patent Application Publication
(10) Pub. No.: US 2005/0197724 A1
(43) Pub. Date: Sep. 8, 2005

(54) System and method to generate audio fingerprints for classification and storage of audio clips

(76) Inventor: Raja Neogi, Portland, OR (US)

Correspondence Address: Blakely, Sokoloff, Taylor & Zafman LLP, 7th Floor, 12400 Wilshire Boulevard, Los Angeles, CA, 90025, US

(21) Appl. No.: 10/796,755

(22) Filed: Mar. 8, 2004

(51) Int. Cl. G06F 17/00; H04R 29/00

(52) U.S. Cl. 700/94; 381/56

(57) ABSTRACT

A system and method to generate audio fingerprints for classification and storage of audio clips. The method includes receiving an unlabeled audio clip. The unlabeled audio clip may be a song about which a user desires to know more information. The unlabeled audio clip is then processed to extract an audio fingerprint. The extracted audio fingerprint is then compared to stored audio fingerprints to determine whether there is a match. If there is a match, then the stored audio fingerprint is used to determine a labeled audio clip. This labeled audio clip is the same as the unlabeled audio clip (e.g., the same song). The labeled audio clip is used to identify the information desired by the user. The information is then provided to the user.

### BACKGROUND

With the rapid growth of the networking infrastructure, the volume of digital media traffic in these networks has climbed dramatically. More and more digital content is produced and consumed in home networks, broadcast networks, video-on-demand (VOD) networks, enterprise networks, Internet protocol (IP) networks and so forth.

With the increased volume of digital media traffic in these networks, it is increasingly difficult to quickly and uniquely identify digital content, such as a particular song, or any particular audio clip. Assume the following scenerio, a person is listening to the radio and hears a song that catches his or her attention. The person knows nothing about the song and would like to know its details (e.g., title, artist, etc.). If the song is heard on the radio, the person may attempt to contact the radio station and inquire about the song details. Unfortunately, this approach is not always practical and is often very cumbersome. It would be convenient if the person could make a simple query to retrieve the song details.

### BRIEF DESCRIPTION OF THE DRAWINGS

The invention may be best understood by referring to the following description and accompanying drawings that are used to illustrate embodiments of the invention. In the drawings:

FIG. 1 illustrates one embodiment of an audio fingerprint system in which some embodiments of the present invention may operate;

FIG. 2 is a flow diagram of one embodiment of a process for generating audio fingerprints for classification and storage of audio clips;

FIG. 3 is a flow diagram of one embodiment of a process for setting up an audio clip/fingerprint database;

FIG. 4 is a flow diagram of one embodiment of a process for generating an audio fingerprint;

FIG. 5 illustrates one embodiment of a fingerprint block in which some embodiments of the present invention may utilize; and

FIG. 6 illustrates a four layer software model of an audio receiver according to an embodiment of the invention.

### DESCRIPTION OF EMBODIMENTS

A method and system to generate audio fingerprints for classification and storage of audio clips are described. Audio fingerprinting of the present invention is an efficent way to identify an unknown or unlabeled audio clip. In general, fingerprinting entails capturing special characteristics that uniquely identify an object amongst others. Because fingerprinting can uniquely identify an object amongst others, it can be used for identification purposes of audio clips.

In general and in an embodiment, the invention receives an unlabeled audio clip. The unlabeled audio clip may be a song about which a user desires to know more information. The unlabeled audio clip is then processed to extract an audio fingerprint. The extracted audio fingerprint is then compared to stored audio fingerprints to determine whether there is a match. If there is a match, then the stored audio fingerprint is used to determine a labeled audio clip. This labeled audio clip is the same as the unlabeled audio clip (e.g., the same song). The labeled audio clip is used to identify the information desired by the user. The information is then provided to the user.

In the following description, for purposes of explanation, numerous specific details are set forth. It will be apparent, however, to one skilled in the art that embodiments of the invention can be practiced without these specific details.

Embodiments of the present invention may be implemented in software, firmware, hardware or by any combination of various techniques. For example, in some embodiments, the present invention may be provided as a computer program product or software which may include a machine or computer-readable medium having stored thereon instructions which may be used to program a computer (or other electronic devices) to perform a process according to the present invention. In other embodiments, steps of the present invention might be performed by specific hardware components that contain hardwired logic for performing the steps, or by any combination of programmed computer components and custom hardware components.

Thus, a machine-readable medium may include any mechanism for storing or transmitting information in a form readable by a machine (e.g., a computer). These mechanisms include, but are not limited to, a hard disk, floppy diskettes, optical disks, Compact Disc, Read-Only Memory (CD-ROMs), magneto-optical disks, Read-Only Memory (ROMs), Random Access Memory (RAM), Erasable Programmable Memory (EPROM), Electrically Erasable Programmable Read-Only Memory (EEPROM), magnetic or optical cards, flash memory, a transmission over the Internet, electrical, optical, acoustical or other forms of propagated signals (e.g., carrier waves, infrared signals, digital signals, etc.) or the like. Other types of mechanisms may be added or substituted for those described as new types of mechanisms are developed and according to the particular application for the invention.

Some portions of the detailed descriptions that follow are presented in terms of algorithms and symbolic representations of operations on data bits within a computer system's registers or memory. These algorithmic descriptions and representations are the means used by those skilled in the data processing arts to convey the substance of their work to others skilled in the art most effectively. An algorithm is here, and generally, conceived to be a self-consistent sequence of operations leading to a desired result. The operations are those requiring physical manipulations of physical quantities. Usually, although not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that discussions utilizing terms such as “processing” or “computing” or “calculating” or “determining” or the like, may refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Reference throughout this specification to “one embodiment” or “an embodiment” means that a particular feature, structure, or characteristic described in connection with the embodiment is included in at least one embodiment of the invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the following detailed description of the embodiments, reference is made to the accompanying drawings that show, by way of illustration, specific embodiments in which the invention may be practiced. In the drawings, like numerals describe substantially similar components throughout the several views. These embodiments are described in sufficient detail to enable those skilled in the art to practice the invention. Other embodiments may be utilized and structural, logical, and electrical changes may be made without departing from the scope of the present invention.

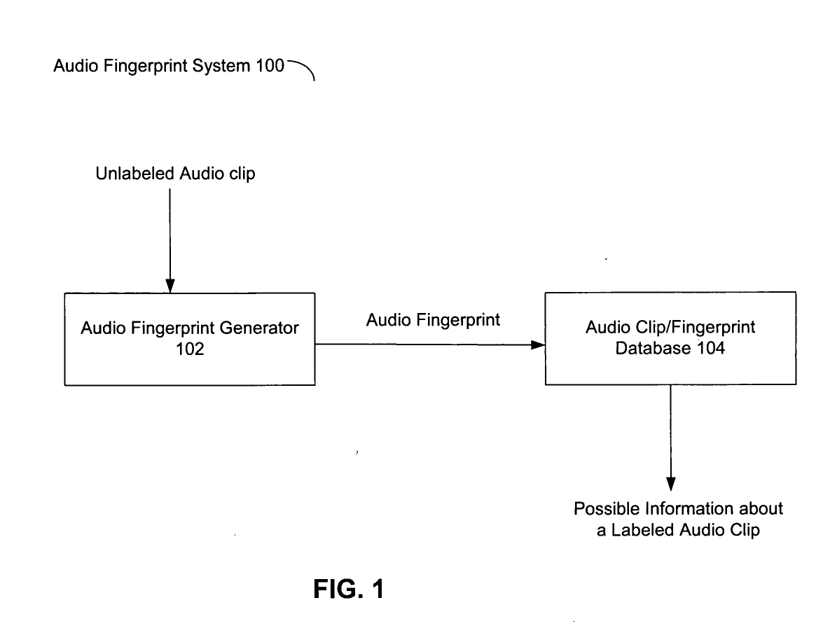

FIG. 1 illustrates one embodiment of an audio fingerprint system 100 in which some embodiments of the present invention may operate. Referring to FIG. 1, audio fingerprint system 100 includes, but is not necessarily limited to, an audio fingerprint generator 102 and an audio clip/fingerprint database 104. Audio clip/fingerprint database 104 is used to classify and store audio clips and their respective fingerprints.

In an embodiment of the invention, an unlabeled audio clip is provided to audio fingerprint generator 102. The unlabeled audio clip may be a song that a user desires to know certain information about, like title, singer, producer, and so forth. Audio fingerprint generator 102 extracts an audio fingerprint from the unlabeled audio clip and provides the extracted audio fingerprint to audio clip/fingerprint database 104. Audio clip/fingerprint database 104 uses the extracted audio fingerprint to compare it to other stored audio fingerprints. If a matching stored audio fingerprint is located, then audio clip/fingerprint database 104 uses the matching stored audio fingerprint to determine a labeled audio clip that matches the unlabeled audio clip. In the example above, audio clip/fingerprint database 104 uses the extracted audio fingerprint to determine if the song that the user is requesting more information about has already been classified and stored. If so, then information about the labeled audio clip (and thus the unlabeled audio clip) is provided to the user.

The information provided by audio clip/fingerprint database 104 may include a variety of items. For example, if the audio clip is a song, then the information may include, but is not necessarily limited to, title of the song, producer of the song, singer of the song, the year the song was released, length of the song, rights to the song, and so forth.

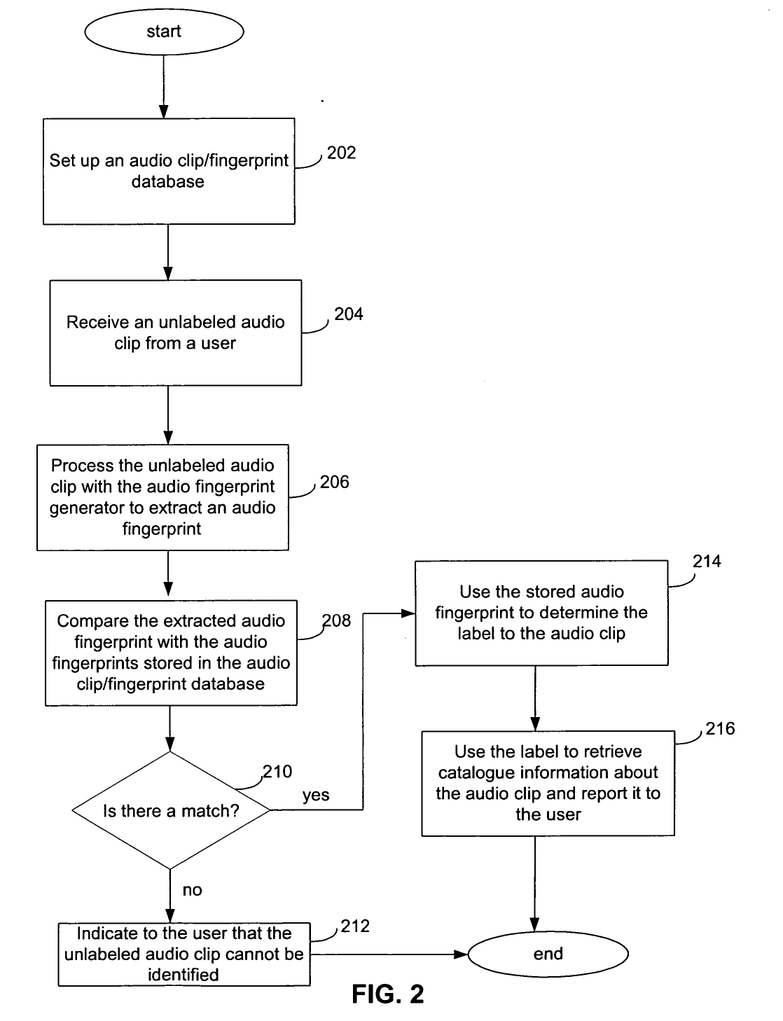

It is to be appreciated that a lesser or more equipped environment than audio fingerprint system 100 may be preferred for certain implementations. Embodiments of the invention may also be applied to other types of software-driven systems that use different hardware architectures than that shown in FIG. 1. An embodiment of the operation of audio fingerprint system 100 is described next with reference to FIGS. 2-6.

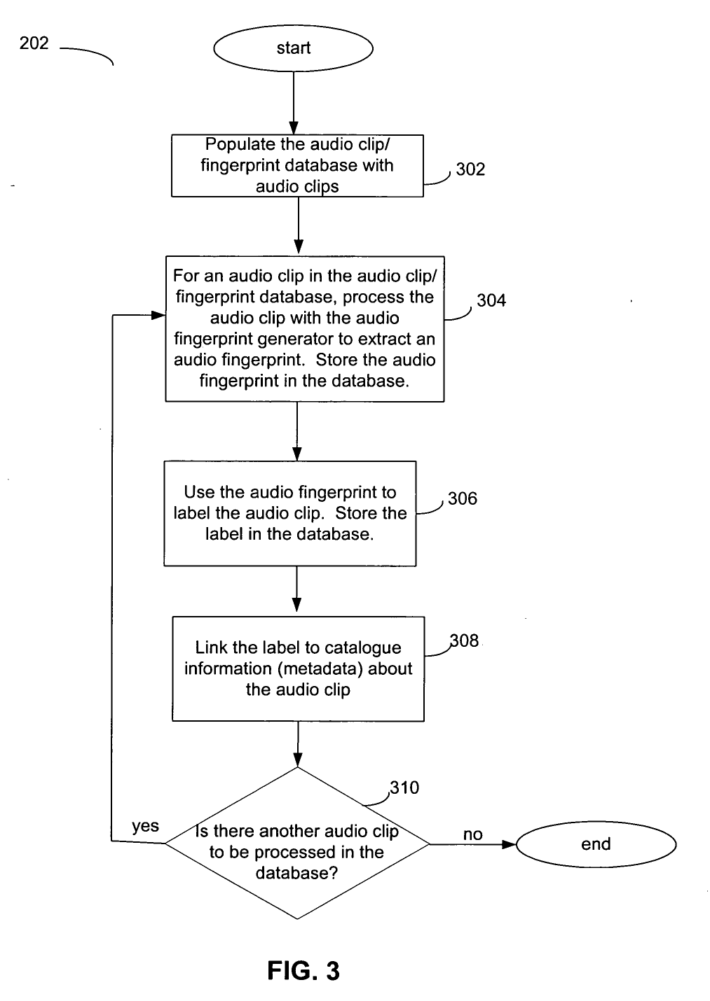

FIG. 2 is a flow diagram of one embodiment of a process for generating audio fingerprints for classification and storage of audio clips. Referring to FIG. 2, the process begins at processing block 202 where audio clip/fingerprint database 104 is set up. Audio clip/fingerprint database 104 may classify and store, but is not necessarily limited to, audio clips, an audio fingerprint (or label) for each of the stored audio clips and metadata (or catalogued information) linked to each label about the audio clip. Processing block 202 is described in more detail below with reference to FIG. 3.

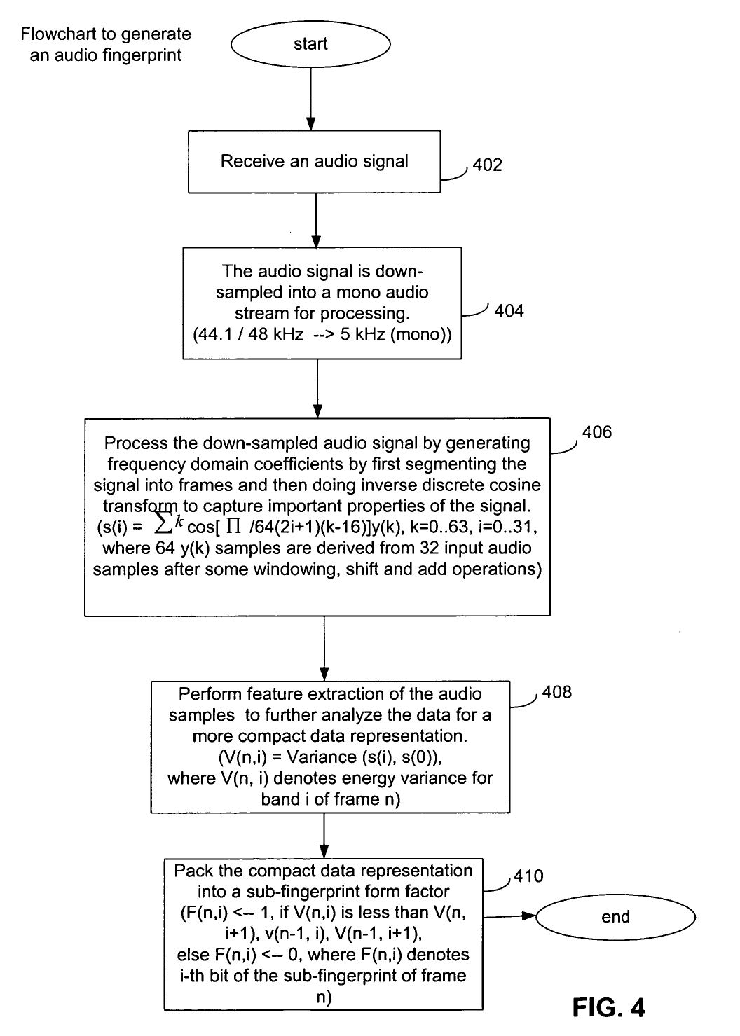

At processing block 204, a user-provided unlabeled audio clip is forwarded to audio fingerprint generator 102. At processing block 206, the unlabeled audio clip is processed by audio fingerprint generator 102 to extract an audio fingerprint. Processing block 206 is described in more detail below with reference to FIGS. 4-6.

At processing block 208, audio clip/fingerprint database 104 attempts to identify the unlabeled audio clip by comparing the extracted audio fingerprint with stored audio fingerprints to determine if there is a match. At decision block 210, if there is no match then the process continues at processing block 212, where audio clip/fingerprint database 104 indicates to the user that the unlabeled audio clip cannot be identified. Alternatively, if at decision block 210 there is a match, then the process continues at processing block 214. In an embodiment of the invention, partial mismatches are analyzed to detect broadcast violations or copyright infringements of audio clips.

At processing block 214, the stored audio fingerprint (that matched the extracted audio fingerprint) is used to determine the label to the matching audio clip. At processing block 216, the label is used to retrieve metadata or catalogued information about the audio clip and report the information to the user. The process in FIG. 2 ends at this point.

FIG. 3 is a flow diagram of one embodiment of a process for setting up audio clip/fingerprint database 104 (step 202 of FIG. 2). Referring to FIG. 3, the process begins at processing block 302 where audio clip/fingerprint database 104 is populated with audio clips. Step 302 is optional since it may not be desirable to store audio clips in audio clip/fingerprint database 104 due to limited storage/resources.

At processing block 304, for an audio clip in audio clip/fingerprint database 104, process the audio clip with audio fingerprint generator 102 to extract an audio fingerprint. The audio fingerprint is then stored in database 104.

At processing block 306, the audio fingerprint is used to label the audio clip. The label is then stored in database 104. At processing block 308, the label is linked to catalogue information (or metadata) about the audio clip. At decision block 310, if there is another audio clip to be processed in database 104, then the process continues back at processing block 304. Otherwise, the process in FIG. 3 ends at this point.

FIG. 4 is a flow diagram of one embodiment of a process for generating an audio fingerprint. Referring to FIG. 4, the process begins at processing block 402 where audio fingerprint generator 102 receives an audio clip or audio signal. In processing block 404 (or PREP stage), the audio signal is down-sampled (averaged) into a mono audio stream for processing. In an embodiment of the invention, the most relevant spectral range for the human auditory system (HAS) is 300 Hz-2 kHz. This means that five samples per second (2× Nyquist limit) will suffice for fingerprinting, where the goal is not to render the audio but rather to capture the summary of the audio object. Audio that needs to be rendered typically has a rate of 44.1 or 48 kHz. Thus, in an embodiment, the audio signal with a sample rate of 44.1 or 48 kHz is down-sampled to a mono audio stream with a sampling rate of 5 kHz. Thus, the following formula may be utilized by the present invention:
44.1/48 kHz→5 kHz (mono).

In processing block 406 (or SPOC stage), the down-sampled audio signal is processed by generating frequency domain coefficients by first segmenting the signal into frames and then doing inverse discrete cosine transform to capture important properties of the signal. In an embodiment of the invention, sixteen bit samples are taken to generate the frequency coefficients since important perceptual audio features live in the frequency domain. The sixteen samples are grouped into frames such that each audio frame has 512 samples. Thus, there are (5*1024/512) frames per second. The goal is to extract the frequency response of 32 band pass filters. In an embodiment, this computation is mapped to 1 D discrete cosine transform in order to re-use the co-processing facilities in the chip. Thus, the following formula may be utilized by the present invention:
s(i)=Σk cos [Π/64(2i+1)(k−16)]y(k), k=0 . . . 63, i=0 . . . 31,
where 64y(k) samples are derived from 32 input audio samples after some windowing, shift and add operations.

In processing step 408 (or FEXT stage), feature extraction of the audio samples are performed to further analyze the data for a more compact data representation. In an embodiment of the invention, coefficient variance with respect to the DC component (s(0)) is calculated. Minimum variance is used as a statistical measure of stability. In an embodiment, the invention is generally interested in stable characteristics of the audio signal. Thus, the following formula may be utilized by the present invention:
V(n,i)=Variance (s(i), s(0)), where V(n, i) denotes energy variance for band i of frame n.

In processing step 410 (of POST stage), the compact data representation is packed into a sub-fingerprint form factor in a fingerprint block. In an embodiment of the invention, the minimum variance from step 408 is mapped to a 32-bit sub-fingerprint, the collection of which forms the fingerprint block. Thus, the following formula may be utilized by the present invention:
F(n,i)←1, if V(n,i) is less than V(n, i+1), V(n−1, i), V(n−1, i+1),
else F(n,i)←0, where F(n,i) denotes i-th bit of the sub-fingerprint of frame n.

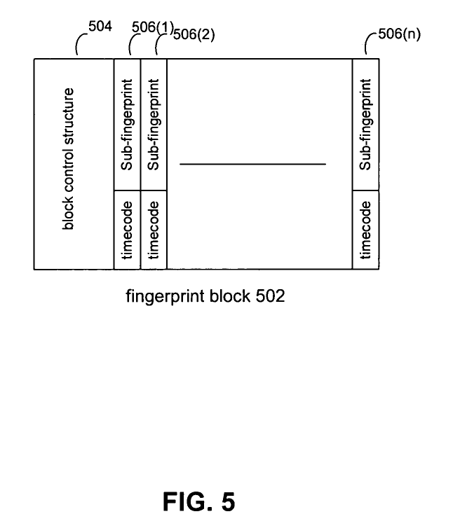

The process in FIG. 4 ends at this point. An embodiment of the fingerprint block is described below with reference to FIG. 5.

FIG. 5 illustrates one embodiment of a fingerprint block in which some embodiments of the present invention may utilize. Referring to FIG. 5, fingerprint block 502 may include, but is not necessarily limited to, the following fields: a block control structure 504 and one or more timecode/sub-fingerprints 506(1) through 506(n). Each sub-fingerprint in timecode/sub-fingerprints 506(1) through 506(n) corresponds to an audio frame. A chain of these sub-fingerprints constitutes a fingerprint block.

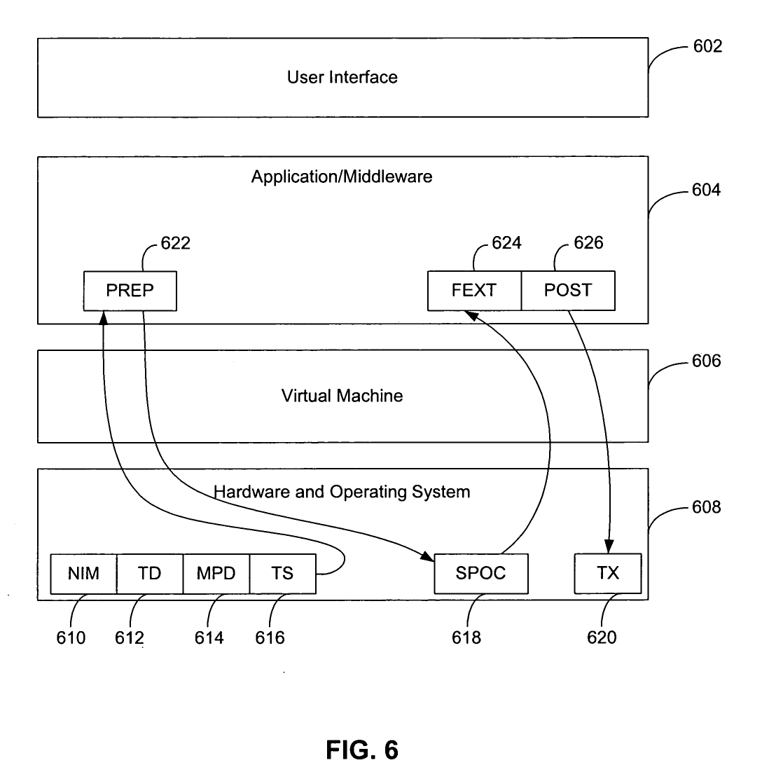

FIG. 6 illustrates a four layer software model of an audio receiver according to an embodiment of the invention. FIG. 6 is shown for illustration purposes only and is not meant to limit the invention. Referring to FIG. 6, the four layers include a user interface layer 602, an application/middleware layer 604, a virtual machine layer 606 and a hardware and operating system layer 608. Each of these layers is briefly described next.

User interface layer 602 listens to client requests and brokers the distribution of these client requests to application/middleware layer 604. Application/middleware layer 604 manages the application state and flow-graph, but is typically unaware of the status of the resources in the network. Virtual machine layer 606 handles resource management and component parameterization. Finally, hardware and operating system layer 608 typically includes the drivers, the node operating system controlling the video receiver, and so forth.

In an embodiment of the invention, each of user interface layer 602, application/middleware layer 604, virtual machine layer 606 and hardware and operating system layer 608 may have components through which data or control is streamed. In an embodiment of the invention, the components are organized as an array data structure.

Example components, not meant to limit the invention, are illustrated in FIG. 6. Hardware and operating system layer 608 has a network interface module (NIM) 610, a transport de-multiplexer (TD) 612, a MPEG decoder (MPD) 614, a storage interface (TS) 616, a down-sampled audio signal component (SPOC) 618, and a packetization and transmission of fingerprint blocks component (TX) 620. Application/middleware layer 604 has a pre-processing component (PREP) 622, a variance array component (FEXT) 624 and a local minima component (POST) 626. Each of these components is described in more detail next.

In an embodiment of the invention in the fingerprint pipeline, a compressed audio signal in MPEG stream will first need to be uncompressed and presented to PREP 622 through buffers in shared memory. Thus, NIM 610 extracts the signal from the channel and passes it to TD 612. TD 612 de-interleaves the audio packets. The compressed audio packets are decompressed by MPD 614 and passed to TS 616 to be stored in persistent storage. TS 616 snoops on the audio traffic for an audio signal and interfaces with a hard drive. The audio signal is forwarded to PREP 622 where the audio signal is down-sampled into a mono audio stream for processing. The down-sampled audio signal is then forwarded to SPOC 618 where it is processed by generating frequency domain coefficients by first segmenting the signal into frames and then doing inverse discrete cosine transform to capture important properties of the signal. The audio samples are then forwarded to FEXT 624 where feature extraction is performed on the audio samples to further analyze the data for a more compact data representation. The compact data representation is then packed by POST 626 into a sub-fingerprint data representation. POST 626 combines a chain of these sub-fingerprints to create a fingerprint block. Thus, uncompressed audio is fed to the fingerprint pipeline, with the fingerprint block coming out of the fingerprint pipeline. The fingerprint block is then forwarded to TX 620 for packetization and transmission.

In an embodiment of the invention, raw digitized uncompressed audio may be directly captured in buffers in shared memory and then stored in a hard drive by TS 616 for consumption by the fingerprint pipeline.

A system and method to generate audio fingerprints for classification and storage of audio clips have been described. It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

1. A method, comprising:
receiving an unlabeled audio clip;
processing the unlabeled audio clip to extract an audio fingerprint;
determining a stored audio fingerprint that matches the extracted audio fingerprint; and
determining a labeled audio clip based on the stored audio fingerprint.

2. The method of claim 1, further comprising:
determining information about the labeled audio clip; and
providing the information to a user.

3. The method of claim 2, wherein the unlabeled audio clip is a song.

4. The method of claim 1, wherein processing the unlabeled audio clip to extract an audio fingerprint comprises:
receiving an audio signal representing the unlabeled audio clip;
down-sampling the received audio signal into a mono audio stream;
processing the down-sampled audio signal by generating frequency domain coefficients to produce one or more audio samples;
performing feature extraction of the one or more audio samples to produce a compact data representation; and
packing the compact data representation into one or more sub-fingerprints.

5. The method of claim 4, wherein processing the down-sampled audio signal by generating frequency domain coefficients to produce one or more audio samples comprises:
segmenting the down-sampled audio signal into one or more frames; and
performing inverse discrete cosine transform on the one or more frames.

6. The method of claim 5, wherein performing inverse discrete cosine transform on the one or more frames captures properties of the down-sampled audio signal.

7. The method of claim 4, wherein the received audio signal is uncompressed.

8. The method of claim 4, further comprising combining the one or more sub-fingerprints to create a fingerprint block.

9. The method of claim 4, wherein the received audio signal has a sample rate of 44.1 kHz and wherein down-sampling the received audio signal into a mono audio stream comprises down-sampling the received audio signal into a mono audio stream with a sampling rate of 5 kHz.

10. The method of claim 4, wherein the received audio signal has a sample rate of 48 kHz and where down-sampling the received audio signal into a mono audio stream comprises down-sampling the received audio signal into a mono audio stream with a sampling rate of 5 kHz.

11. The method of claim 4, wherein the sub-fingerprint is 32 bits.

12. A system, comprising:
an audio fingerprint generator; and
a database,
wherein the audio fingerprint generator receives an unlabeled audio clip and wherein the audio fingerprint generator processes the unlabeled audio clip to extract an audio fingerprint,
wherein the database determines a stored audio fingerprint that matches the extracted audio fingerprint and wherein the database determines a labeled audio clip based on the stored audio fingerprint.

13. The system of claim 12, wherein the database determines information about the labeled audio clip and wherein the database provides the information to a user.

14. The system of claim 13, wherein the unlabeled audio clip is a song.

15. The system of claim 12, wherein the audio fingerprint generator processes the unlabeled audio clip to extract an audio fingerprint by receiving an audio signal representing the unlabeled audio clip, down-sampling the received audio signal into a mono audio stream, processing the down-sampled audio signal by generating frequency domain coefficients to produce one or more audio samples, performing feature extraction of the one or more audio samples to produce a compact data representation and packing the compact data representation into one or more sub-fingerprints.

16. The system of claim 15, wherein the audio fingerprint generator processes the down-sampled audio signal by segmenting the down-sampled audio signal into one or more frames and performing inverse discrete cosine transform on the one or more frames.

17. The system of claim 16, wherein performing inverse discrete cosine transform on the one or more frames captures properties of the down-sampled audio signal.

18. The system of claim 15, wherein the received audio signal is uncompressed.

19. The system of claim 15, wherein the audio fingerprint generator combines the one or more sub-fingerprints to create a fingerprint block.

20. The system of claim 15, wherein the received audio signal has a sample rate of 44.1 kHz and wherein the audio fingerprint generator down-samples the received audio signal by down-sampling the received audio signal into a mono audio stream with a sampling rate of 5 kHz.

21. The system of claim 15, wherein the received audio signal has a sample rate of 48 kHz and wherein the audio fingerprint generator down-samples the received audio signal by down-sampling the received audio signal into a mono audio stream with a sampling rate of 5 kHz.

22. The system of claim 15, wherein the sub-fingerprint is 32 bits.

23. A machine-readable medium containing instructions which, when executed by a processing system, cause the processing system to perform a method, the method comprising:
receiving an unlabeled audio clip;
processing the unlabeled audio clip to extract an audio fingerprint;
determining a stored audio fingerprint that matches the extracted audio fingerprint; and
determining a labeled audio clip based on the stored audio fingerprint.

24. The machine-readable medium of claim 23, further comprising:
determining information about the labeled audio clip; and
providing the information to a user.

25. The machine-readable medium of claim 24, wherein the unlabeled audio clip is a song.

26. The machine-readable medium of claim 23, wherein processing the unlabeled audio clip to extract an audio fingerprint comprises:
receiving an audio signal representing the unlabeled audio clip;
down-sampling the received audio signal into a mono audio stream;
processing the down-sampled audio signal by generating frequency domain coefficients to produce one or more audio samples;
performing feature extraction of the one or more audio samples to produce a compact data representation; and
packing the compact data representation into one or more sub-fingerprints.

27. The machine-readable medium of claim 26, wherein processing the down-sampled audio signal by generating frequency domain coefficients to produce one or more audio samples comprises:
segmenting the down-sampled audio signal into one or more frames; and
performing inverse discrete cosine transform on the one or more frames.

28. The machine-readable medium of claim 27, wherein performing inverse discrete cosine transform on the one or more frames captures properties of the down-sampled audio signal.

29. The machine-readable medium of claim 26, wherein the received audio signal is uncompressed.

30. The machine-readable medium of claim 26, further comprising combining the one or more sub-fingerprints to create a fingerprint block.

31. The machine-readable medium of claim 26, wherein the received audio signal has a sample rate of 44.1 kHz and wherein down-sampling the received audio signal into a mono audio stream comprises down-sampling the received audio signal into a mono audio stream with a sampling rate of 5 kHz.

32. The machine-readable medium of claim 26, wherein the received audio signal has a sample rate of 48 kHz and where down-sampling the received audio signal into a mono audio stream comprises down-sampling the received audio signal into a mono audio stream with a sampling rate of 5 kHz.

33. The machine-readable medium of claim 26, wherein the sub-fingerprint is 32 bits.
